(19) United States
(12) Patent Application Publication
(10) Pub. No.: US 2004/0085355 A1
(43) Pub. Date: May 6, 2004

(54) Collaborative contract management system, apparatus and method

(76) Inventors: Jeffrey E. Harmes, Bainbridge Island, WA (US); David Keith Jensen, San Diego, CA (US); Michael Faik Tominna, San Diego, CA (US)

Correspondence Address: MARK M. TAKAHASHI, GRAY CARY WARE & FREIDENRICH, LLP, 4365 EXECUTIVE DRIVE, SUITE 1100, SAN DIEGO, CA, 92121-2133, US

(21) Appl. No.: 10/286,392

(22) Filed: Oct. 31, 2002

(51) Int. Cl. G09G 5/00

(52) U.S. Cl. 345/751; 345/780

(57) ABSTRACT

A collaborative contract management system integrates the collaborative creation of contract documents, the collaborative negotiation of the contents of those documents, and the management of executed contracts, thereby enabling multiple parallel users to work collectively on the creation, negotiation, and management of contracts. The multiple parallel users communicate with a contract server to access a database containing electronic contracts documents arranged into a plurality of files based on a contract status. A graphical user interface presented through a display at any active user terminal includes graphical representations of the files. The multiple parallel users can easily navigate through the database using the graphical user interface to create and view contract documents, view relationships between contract documents, track versions of contracts, access documents for editing, copying, or annotating during negotiation, track executed documents, and otherwise manage executed contracts.

### BACKGROUND OF THE INVENTION

The invention relates in general to electronic file management and more specifically to a method, apparatus and system for drafting, negotiating, and managing contracts through multiple user terminals.

Individuals, companies, and a variety of organizations enter into and perform legal contracts. Often, the negotiating process leading to an acceptable and executed contract between two or more parties is lengthy and generates a number of contract revisions. Comments are regularly used during negotiation to convey reasons for adding language to or deleting language from a contract, to convey concerns regarding the consequences of portions of the contract and to convey other concerns or issues. The comments may be directed to the parties of the contract, members negotiating on one side of an agreement, or to select members of one or both groups. Conventional methods for tracking, archiving and communicating contract revisions and other information include paper document storage and dissemination as well as digital data storage and transmission. For example, paper copies of contract revisions and executed contracts can be mailed through the postal service sent using a courier service or directly exchanged between parties of members of a party. Paper copies can be stored in a file cabinet. Other conventional techniques of sharing information regarding contracts include transmission via facsimile and email. Also, contracts and other related documents can be stored in digital form in databases and on digital storage media such as computer hard drives, CDROMS and memory diskettes.

Once a contract has been negotiated and executed, conventional management of contracts and related files is limited in several ways, however. In this regard management of a contract refers not only to maintenance and archiving of documents, but also to supervision of performance required by the contract, and verification of scheduled events. Large organizations often have a large number of executed contracts and contract templates or forms. Management of these and other relevant documents is difficult and results in errors. Original executed documents are typically stored in a file cabinet making it difficult for personnel to quickly determine if a contract exists, who executed the contract, when the contract was executed, the terms of the contract, and whether the terms are different from the preferred form used by the organization. Further, where similar forms or templates exist, conventional contract management techniques often do not provide adequate information indicating what circumstances warrant using one template over another, which provisions in these templates are considered to be negotiable, and what the preferred negotiating strategies are. Moreover, the monitoring and reporting of performance, schedules, and milestones is usually performed using manual means that are separate from the documents that memorialize a contract.

The process of creating, negotiating, and managing contracts is intensely collaborative, especially as concerns the creation of an initial set of contract documents and the negotiation of the terms, conditions, and language of a contract. Historically, collaboration has been realized by physical proximity-meeting in the same room, using the same filing cabinets and by maintaining multiple, parallel files, with drafts, exhibits, and other related documents. Modern technology which affords parallel multi-user access to meeting, database and version control functions enhances the ability of teams to work collaboratively in the creation and negotiation of contracts.

Nevertheless, full advantage has not been taken of the potential of modern computing and communications to be adapted for an integrated functional architecture that provides means and methods for integrating the collaborative initial creation of contract documents, the collaborative negotiation of the content of contract documents following their creation up to their execution, and the management of executed contracts.

### BRIEF DESCRIPTION OF THE DRAWINGS

FIG. 1 is block diagram of a contract management system in accordance with an exemplary embodiment of the invention.

FIG. 2 is a block diagram of a graphical representation of an exemplary main page of the graphical user interface (GUI).

FIG. 3 is a block diagram illustrating an exemplary organization of the contract management memory.

FIG. 4 is a block diagram of a graphical representation of an exemplary contract forms page of the graphical user interface (GUI).

FIG. 5 is a block diagram of a graphical representation of an exemplary first level active contracts page of the graphical user interface (GUI).

FIG. 6 is a block diagram of a graphical representation of an exemplary second level active contracts page of the graphical user interface (GUI).

FIG. 7 is a block diagram of a graphical representation of an exemplary active contracts documents page of the graphical user interface (GUI).

FIG. 8 is a flow chart of a method of managing electronic contract documents in accordance with the exemplary embodiment of the invention.

FIG. 9 is a block diagram of an aspect of the system for managing executed contracts.

FIG. 10 is a block diagram of an exemplary executed contracts database page of the graphical user interface (GUI).

FIG. 11 is a flow chart of a method for managing executed contract events.

### DETAILED DESCRIPTION OF THE PREFERRED EMBODIMENTS

The invention concerns collaborative means and methods for creation, negotiation and management of contracts. More particularly, the invention facilitates creation, negotiation and management of contracts through electronic storage, processing, and access. A graphical user interface (GUI) is provided through displays at user terminals allowing any number of multiple parallel users to access contract forms, negotiate a contract with multiple other users, including representatives of the parties to the contract being negotiated, and to monitor performance, events, and milestones of executory contracts. Any user can quickly and easily access the appropriate contract documents to create, edit, store, group, associate, link, organize, tag, or copy contract documents. Additional information can be stored for an individual document or groups of documents to assist the user in tracking, understanding, organizing, associating, grouping, negotiating, revising or otherwise managing the contracts. Several terminals connected to a server system allow access by multiple parallel users at different locations. Therefore, contract documents as well as data describing the contracts can be conveyed between members of a party, or members of different parties, and can be easily accessed and memorialized allowing an efficient management of contracts.

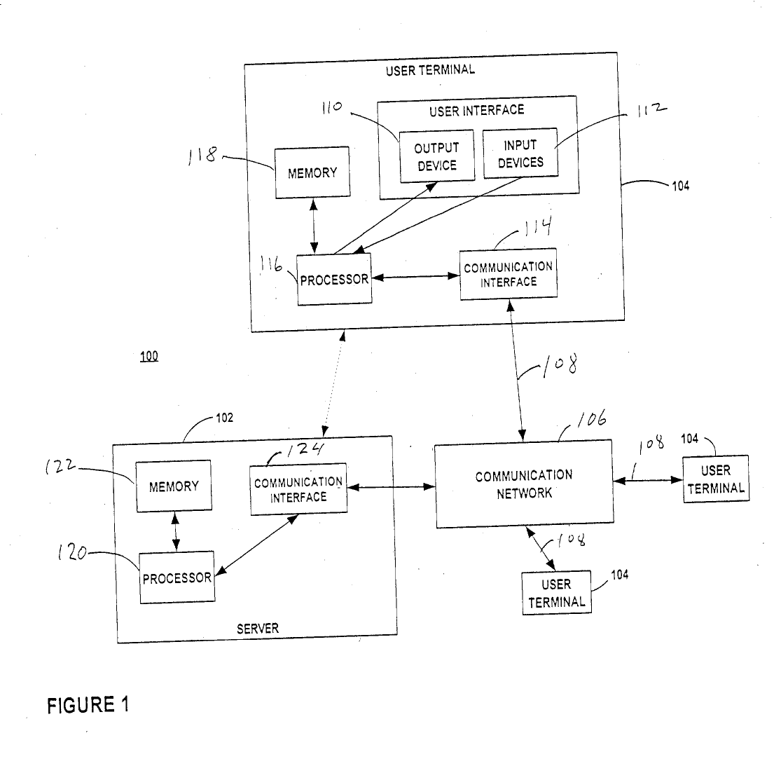

FIG. 1 is a block diagram of a contract management system 100 in accordance with an exemplary embodiment of the invention. The contract management system 100 includes at least a contract management server 102 and one user terminal 104. Several user terminals 104, however, may be connected to one or more contract servers 102 either directly or through one or more communication networks 106. In the exemplary embodiment, the communication network 106 is any network that supports Hypertext Transfer Protocol (HTTP) or Hypertext Transfer Protocol over Secure Socket Layer (HTTPS) such as the Internet and may include several computer networks connected through an array of communication links. Messaging information and data are routed through the communication network 106 using internet protocol (IP) addressing techniques. Data and other information is organized into packets and appropriate headers are appended to the packets in accordance with HTTP and TCP/IP protocols. Although the communication network 106 is the Internet in the first embodiment, those skilled in the art will recognize that the following discussion applies to other types of communication networks including packet switched networks, virtual private networks, local area networks (LANs) and wireless local area networks (WLANS). For example, the communication network 106 may be any one of various computer networks utilizing communication technologies such as Ethernet or token ring communication techniques. The communication network 106, therefore, may be an Intranet system implemented as a private network for a group of users. Preferably, the communication network 106 uses Transmission Control Protocol/Internet Protocol (TCP/IP) techniques typically used with the Internet including Hypertext Transfer Protocol (HTTP) and Hypertext Markup Language (HTML) principles. Another suitable markup language is the extended markup language (XML). Other embodiments may be built upon protocols other than HTTP and TCP/IP.

The user terminal 104 may be any one of various processors or computers such as personal computers, workstations, laptop computers, personal digital assistants or any other type of computing devices capable of communicating through the communication network 106. The user terminal 104 is connected to the communication network 106 through an access link 108 using any one of various known methods. For example, the access link 108 may include an Internet service provider within the communication network 106 or a private server coupled to the user terminal 104. As those skilled in the art will recognize, a portion of the access link 108 may be circuit switched. In typical access links 108 using an Internet provider server, the user terminal 104 is coupled to the Internet provider server through a modem and telephone line. Examples of other types of access links 108 suitable for coupling the local processor 102 to the communication network 106 include cable modem systems and digital subscriber line (DSL) systems. The present invention is not limited to any particular access link 108.

A user accesses the contract management system 100 through a user interface 106 of the user terminal 104. The user interface 106 includes at least one output device 110 for receiving information and at least one input device 112 for entering information. Several input devices 112 and output devices 110 can be used to interface with the user terminal 104. In the exemplary embodiment, the output device 110 is a display such as a video monitor and the input device 112 includes a keyboard and a computer mouse. Examples of other suitable input devices 112 include track balls, touch screen displays, touch pads, joysticks, and microphones. Other types of output devices 110 that can be used include projectors and audio speakers.

As explained below in further detail, a graphic user interface displayed on the output device 110 provides contract information categorized into a plurality of contract status groups. In the exemplary embodiment, the electronic contract documents, comments, and other associated information are organized into a form file, an active contracts file, and an executed contracts file. The graphical user interface (GUI) provides visual representations of the files and conveys at least some of the organization of the stored subject matter. The user can retrieve information such as a contract document and view the contents on the display (110). Using the input devices 112, and depending on the type of contract document, the user may edit, print, append other documents to, or add comments linked to the particular document or sections of a document. The user can store and view different versions of documents and search the text of documents for words and phrases. The user may also create data fields for stored documents, using pre-selected fields or customized fields. One or more of these fields may include events, such as contract renewal or performance deadlines, and the user may cause the system to send e-mail reminders of the dates upon which these events occur.

The user may create separate folders in the system and assign an e-mail address for each such folder. Utilizing such addresses, the user may cause e-mail messages and documents attached to such messages to be forwarded to the appropriate folder, allowing the user to create an archive of e-mail messages and corresponding document versions for a particular transaction or negotiation.

Fields are provided in each folder for the user to post comments to other users concerning the documents and templates in the folder, such as suggestions for changes or improvements, or requests for guidance with respect to specified issues related to the documents.

A communication interface 114 at the user terminal 104 provides a mechanism for interfacing to the communication network 106 and communicating with the contract server 102. Examples of communication interfaces include modems and Ethernet cards. In the exemplary embodiment, the user terminals 104 exchange signals through an Internet Protocol (IP) network in accordance with known techniques. The communication interface 114 in the exemplary embodiment, therefore, provides a connection from a processor 116 of the user terminal 104 to the IP network. The user terminals 104, however, may be connected directly to the server 102 using other suitable techniques and may be connected through other types of networks or in other configurations such as in a ring, loop or bus as discussed above.

The processor 116 and memory 118 provide a platform for running software code that facilitates the contract management functions discussed herein as well as the overall functionality of the user terminal 104. The processor 116 may be any type of processor, microprocessor, processor arrangement, processor combination or computer capable of performing the tasks related to contract management, control and communication.

In addition to facilitating the running of software on the processor 116, the memory 118 provides storage for files, documents, control settings, application software and other information and data. In the exemplary embodiment, the memory 118 includes random access memory (RAM) and read only memory (ROM).

In the exemplary embodiment, a Web browser application installed and running on the user terminal 104 provides access through the World Wide Web (often referred to as the “Web”) to the contract server 102. As is known, a Web browser is a computer program that allows the user to view, download, upload, “surf” or otherwise access documents or pages on the Web. Examples of suitable web browsers for use with the present invention include Netscape Navigator and Microsoft Internet Explorer. A user accesses a Web page by designating the destination address of the page on the Internet to the Web browser. The Web browser transmits a message using the HTTP protocol and Uniform Resource Locator (URL) techniques including the destination address and an address of the user terminal 104. As is known, a URL describes the location and access method of a resource on the Internet. A suitable protocol for use in accordance with the invention is the Hypertext Transfer Protocol (HTTP). As is known, the IP address of the user terminal 104 may be provided by the Internet service provider as a default or temporary IP address or may be a permanent IP address assigned to the user terminal 104 using other methods. The contract server 102 hosting the Web page transmits messaging information, data and Web pages back to the user terminal 104 through the communication network 106 using the user terminal 104 address and the HTTP protocol. Messages transmitted from the contract server 102 may include text and graphics to be displayed, hidden text, commands or instructions to the Web browser or small application programs often referred to as “applets.” The Web browser processes the transmitted messages to perform the functions which may include displaying text or graphical information, producing audio information, storing data or performing a command such as opening a new Web browser window.

The contract server 102 includes at least a processor 120, memory 122 and may include a communication interface 124. In the exemplary embodiment, the contract server 104 is a general purpose, programmed digital computer or processor such as a Compaq® DL380 comprising two processors running at 1.26 GHz running a Windows 2000 server operating system with IIS 5.0 and eRoom 5.4. The contract server 102, however, may be any one of several commercially available server computers with an appropriate operating system. The processor 120 is any suitable processor capable of running a operating system and performing the tasks described herein. Examples of other types of suitable operating systems include LINUX and UNIX operating systems. Various application software running on the operating system facilitate communication through communication interface 124 and the communication network 106 in addition to providing the contract management service. The contract server 102 may include several interconnected processors communicatively coupled in an arrangement suitable for performing the functions described herein. Such a server arrangement, for example, may be interconnected using fiber optic cables. Although the contract server 104 provides the contract management service to the users, the contract server 104 may provide any number of additional services such as email services or access to other software programs.

A memory in the contract server 102 provides electronic storage for a variety of information and is sufficient to maintain databases including the contract documents and related information. The memory can be any combination of RAM and ROM and may be internal to the contract server, co-located with the contract server, remotely located or distributed.

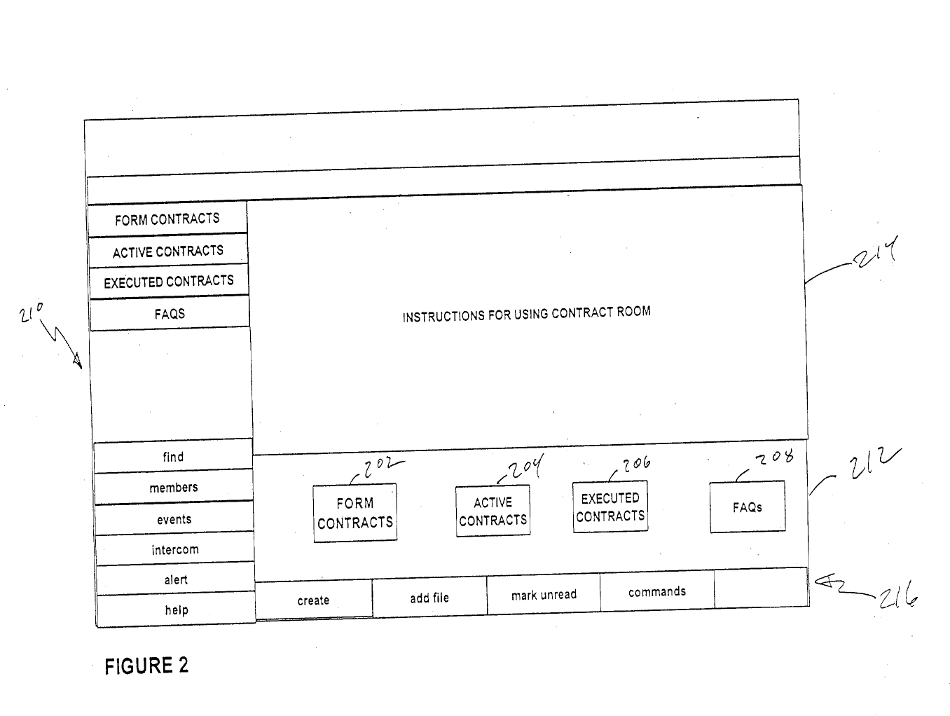

FIG. 2 is a block diagram of a graphical representation of an exemplary main page 200 of the graphical user interface (GUI). As explained above, a Web browser application running on the user terminal 104 facilitates communication through the communication network 106 and the contract server 102. Although other methods can be used, user access to the GUI is controlled using user name and passwords in the exemplary embodiment. After entering the appropriate information through a sign-in screen or Web page, the user gains access to the main page 200 of the contract management system 100. In the exemplary embodiment, users having a relationship with an organization, such as a large company for example, can access the main page 200 to manage contract documents associated with the organization.

The main page 200 includes any number of icons 202-208, tool bars 216, navigation bars 210 and other graphics to convey the organization and relationship between the various groups of documents as well as facilitating navigation within the contract management system 100 and other user interaction. The main page 200 includes at least icons 202-206 representing the various files containing the contract documents. In the exemplary embodiment, a form contract icon 202 represents the form contract file, an active contract icon 204 represents the active contracts file and an executed contracts icon 206 represents a file through which the executed contracts database and associated processing may be accessed. The main page 200 may include other icons 208 representing other files. An example of another type of file is a frequently asked questions (FAQs) file that is represented by a FAQ icon 208 in the exemplary embodiment. When one of the icons 202-206 is selected, by single clicking for example, a file page is opened. The file pages include graphics that facilitate further interaction within a particular file and are discussed below in further detail.

In the exemplary embodiment, the main page 200 includes a block navigation bar 210, a file room graphic 212, a text box 214, and an action bar 216. The block navigation bar 210 allows the user to access the various files 202-206, and other pages such as the FAQs file 208. Other pages that can be accessed through the block navigation bar 210 include a find page, members page, events page, intercom page alert page and help page.

The file room graphic 212 includes links to the files containing the electronic contract documents. As explained above, the files are represented with graphics or such as icons 202-206. Therefore, a graphical user interface (200) is presented to the user though the user terminal and includes graphics representing the files that include electronic contract documents arranged by contract status. Although in the exemplary embodiment, the contract status is organized into three level of status (form status, active status, and executed status), other status levels can be used. For example, the executed status can be organized and arranged such that documents are designated as either belonging to an in effect status or an expired status. The status can also be organized by name of party or type of contract.

The form contracts file includes templates or forms for standard contracts used by the organization. The form contracts file may include annotated versions and non-annotated versions of the forms. By accessing the form contracts file, the user can view and copy electronic contract documents. In the exemplary embodiment, the documents are stored in a format readable by a word processing application such as the MS Word application available from Microsoft. With the appropriate authorization, the user can edit the stored documents, delete documents, and add documents. The form contracts file can be used to track and archive versions of the organization's form contracts. For example, the user can determine which contract form versions were in effect on a particular date.

In the exemplary embodiment, the user accesses the form contract file by clicking on the form contracts icon 202 or on the appropriate button in the navigation bar. The GUI provides a form contract page which includes a list of electronic contract form documents. The form contract page may include a variety of information related to the electronic contract forms documents as well as other navigation buttons and files. In the exemplary embodiment, each electronic contract form document listed in the form contract page includes document name, contract type, author, and the date created.

In order to access the active contracts file, the user clicks on the active contracts file 204 or the appropriate button in the navigation bar. In response, the GUI provides an active contracts page. The active contracts page includes information related to current contract negotiations and can include a list of documents, folders related to a particular contract negotiation, and other information and buttons. In the exemplary embodiment, the information is organized within folders and sub folders where a folder is dedicated to each contract negotiation. An example illustrating a suitable organization includes a party folder for each party with which the organization is negotiating at least one contract and a contract folder within each party folder for each contract that is currently in negotiation. The contract folder may include multiple versions of the contract, versions with annotations, redline versions and documents related to the various contract versions.

The executed contracts file is accessed by clicking on the executed contracts icon 206 or the appropriate button in the navigation bar within the main page. In response, the GUI provides an executed contracts page that includes information related to executed contracts. In the exemplary embodiment, an electronic version in word processing application is stored as well as a electronic image of the actual executed contract. For example, a MS Word file as well as a Portable Document Format (PDF) file can be stored for any given contract. The electronic documents can be stored in a variety architectures and organizations. Folders and subfolders are an example of a suitable method for storing information within the executed contracts file.

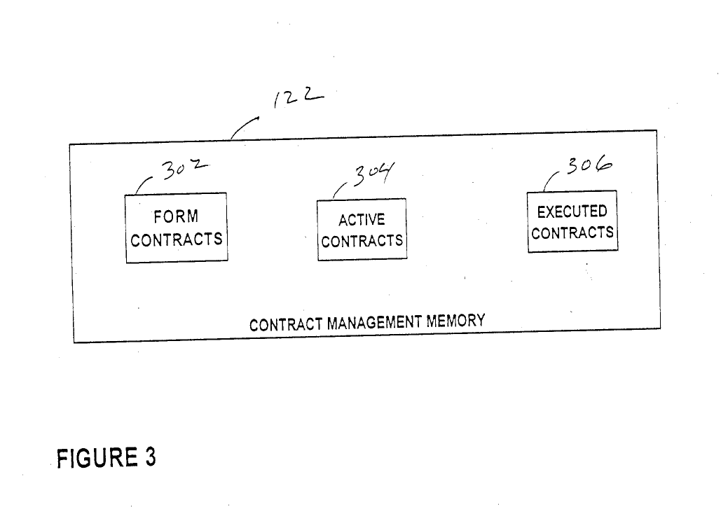

FIG. 3 is a block diagram illustrating an exemplary organization of the contract management memory 122. The contract management database is implemented in the contract management memory 122 accessible by the server 102 in the exemplary embodiment. The memory 122 may be part of the server memory or may be a separate memory connected to the server using known techniques. Also, the memory may be distributed over more than one physical location or device and may also be implemented to include redundant information.

The contract management memory 122 includes at least two electronic files for retaining the electronic contracts documents pertaining to two contract categories. In the exemplary embodiment, the contract management 122 memory includes an form contracts electronic file 302, an active contracts electronic file 304, and an executed contracts electronic file 306. Electronic contract documents associated with the form contracts category are stored in the form contracts electronic file 302. Electronic contract documents associated with the active contracts category are stored in the active contracts electronic file 304. Electronic contract documents associated with the executed contracts category are stored in the executed contracts electronic file 306, as are links to an executed contracts database and associated contracts management processing. Any number of known techniques for storing data associated within a particular category can be used to store the electronic documents as described above. For example, File Allocation Tables (FATs) can be used to store the electronic contract documents such that the documents with each electronic file 302, 304, 306 are associated with the appropriate contract category.

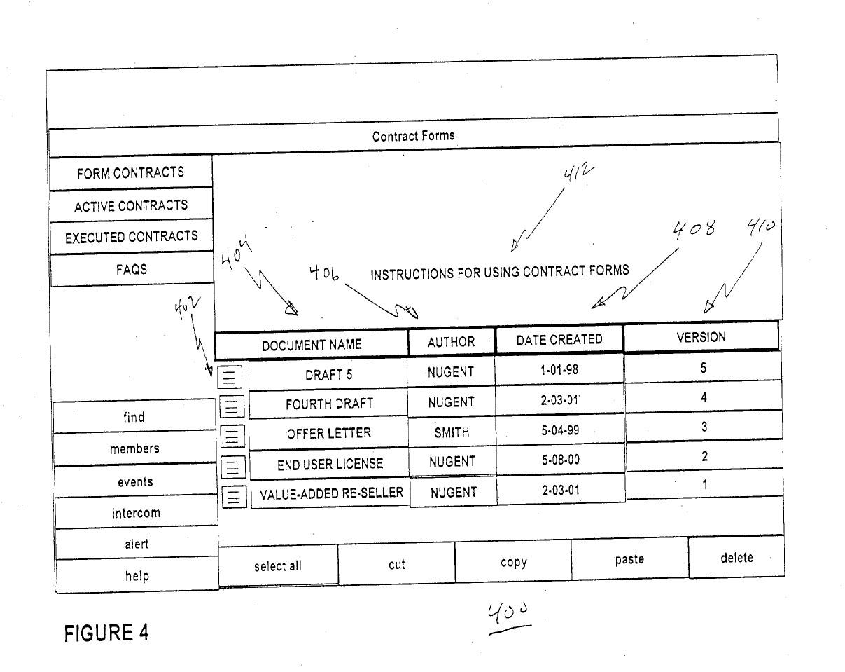

FIG. 4 is a block diagram of a graphical representation of an exemplary contract forms page 400 of the graphical user interface (GUI). The contract forms page is displayed to the user in response to a user command. In the exemplary embodiment, the user selects the contract forms page by single clicking an icon in a web page such as the home contracts page 200. Other techniques, however, can be used to send a command to the contract server 102. The Web browser software running on the user terminal 104 renders a screen in accordance with the messages sent by the server 102. The contract forms page 400 includes several items and a variety of information and may be formed with any number of fonts, shapes, symbols, or colors. The contract form page 400, however, includes at least a representation (402) of the electronic contract documents associated with the forms contract category for the organization. In the exemplary embodiment, the contract forms page 400 includes, for each electronic contract document in the category, an icon 402, a document name 404, a contract type 406, and author 408, and a date created 410. The contract form page 400 may include other buttons or icons that are included in the contracts home page 200 as well as other information. For example, the contracts forms page 400 may include instructions 412 for using the page 400. The user can access a particular electronic document by submitting the appropriate user command. In the exemplary embodiment, the user single clicks on the appropriate icon 402 to send the user command. In response, the server allows access to corresponding electronic contract document.

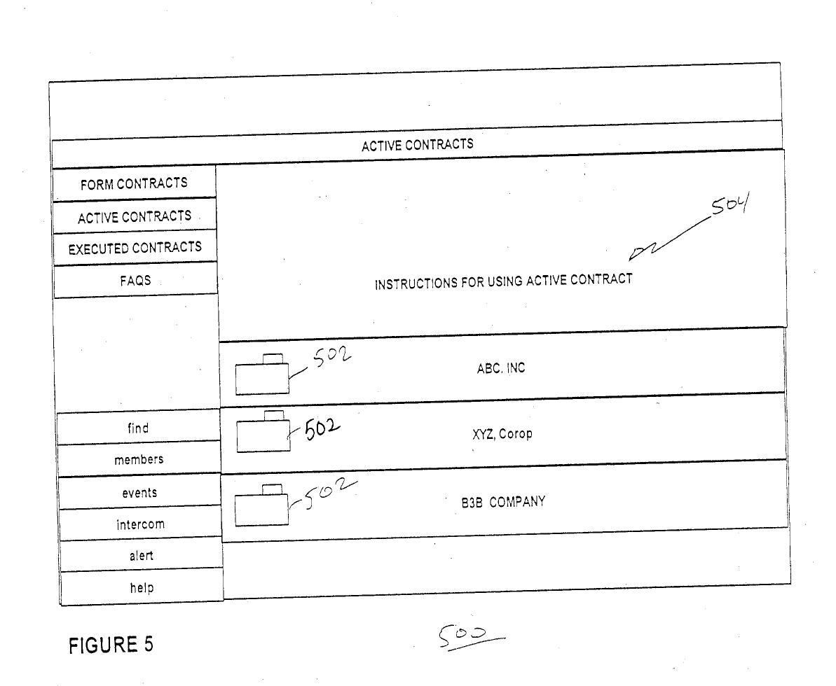

FIG. 5 is a block diagram of a graphical representation of an exemplary first level active contracts page 500 of the graphical user interface (GUI). In response to submitting a user command to access the electronic documents associated with the active contracts category, the server provides instructions to the Web browser to create the first level active contracts page 500. The first level active contracts page includes at least one folder 502 representing the active contracts associated with an organization. Each folder is associated with a single organization in the exemplary embodiment. The first level active contracts page 500 may include other buttons or icons that are included in the contracts home page 200 as well as other information. For example, the first level active contracts page 500 may include instructions 504 for using the page 500. The user can access the contents of a particular electronic folder 502 by submitting the appropriate user command. In the exemplary embodiment, the user single clicks on the appropriate icon 502 to send the user command. In response, the server allows access to the corresponding electronic folder 502.

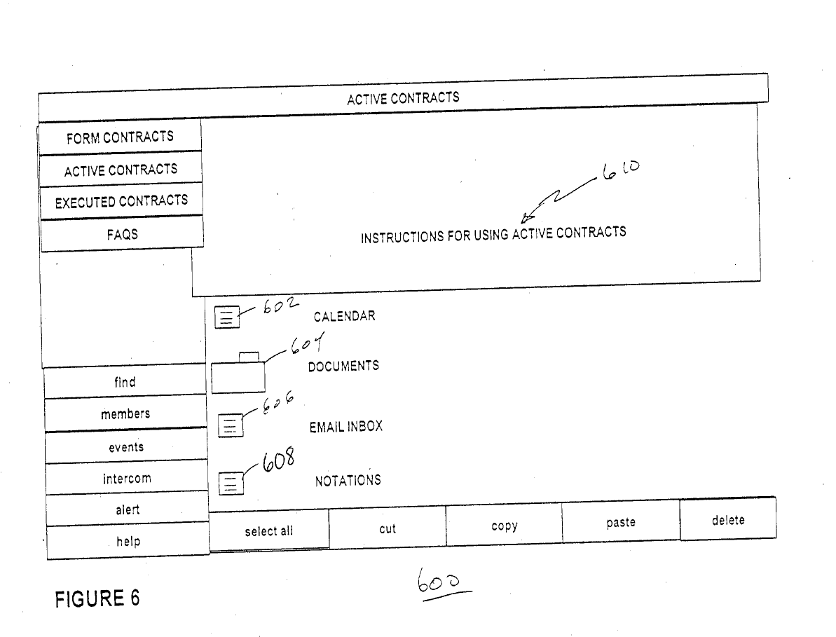

FIG. 6 is a block diagram of a graphical representation of an exemplary second level active contracts page 600 of the graphical user interface (GUI). In response to submitting a user command to access the electronic documents associated with an electronic folder 502, the server provides instructions to the Web browser to create the second level active contracts page 600. In the exemplary embodiment, the second level active contracts page includes calendar file 602, a documents file 604, and email inbox 606, and a notations file 608. Each folder 602-608, therefore, is associated with a single organization in the exemplary embodiment. The second level active contracts page 600 may include other buttons or icons that are included in the contracts home page 200 as well as other information. For example, the second level active contracts page 600 may include instructions 610 for using the page 600. The user can access the contents of a particular electronic folder 602-608 by submitting the appropriate user command. In the exemplary embodiment, the user single clicks on the appropriate folder icon 602-608 to send the user command. In response, the server allows access to the corresponding electronic folder 602-608.

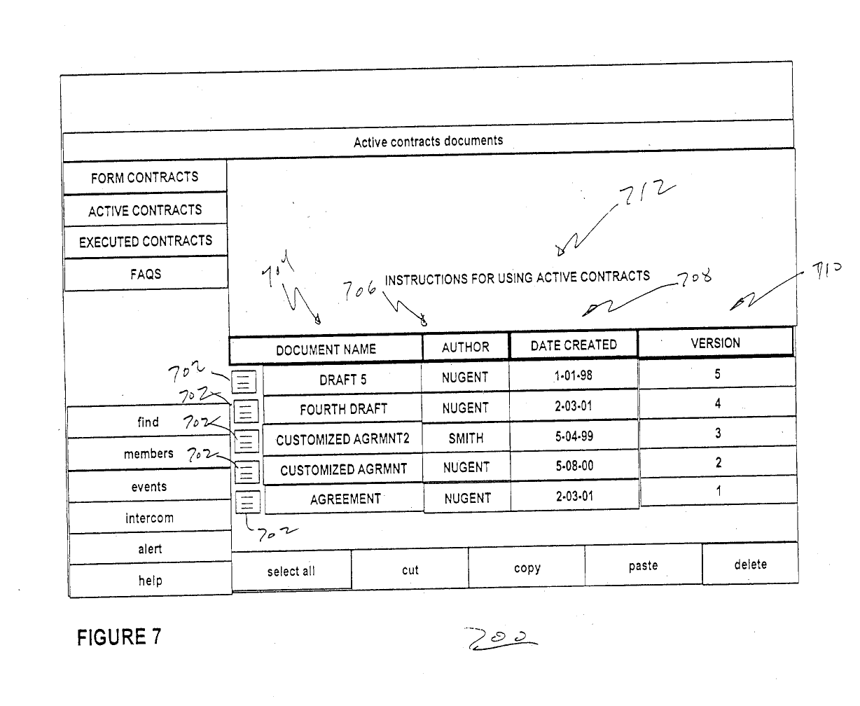

FIG. 7 is a block diagram of a graphical representation of an exemplary active contracts documents page 700 of the graphical user interface (GUI). In response to submitting a user command to access electronic document versions associated with an electronic contract document, the server provides instructions to the Web browser to create the active contracts documents page 700. The active contracts documents page 700 includes at least one version document icon 702 representing an active contract document associated with the organization. Each electronic document includes a name 704, an author, 706, a date created 708 and a version 710. The active contracts documents page 700 may include other buttons or icons that are included in the contracts home page 200 as well as other information. For example, the active contracts documents page 700 may include instructions 712 for using the page 700. The user can access the particular version of the electronic document by submitting the appropriate user command. In the exemplary embodiment, the user single clicks on the appropriate icon 702 to send the user command. In response, the server allows access to the corresponding electronic document version.

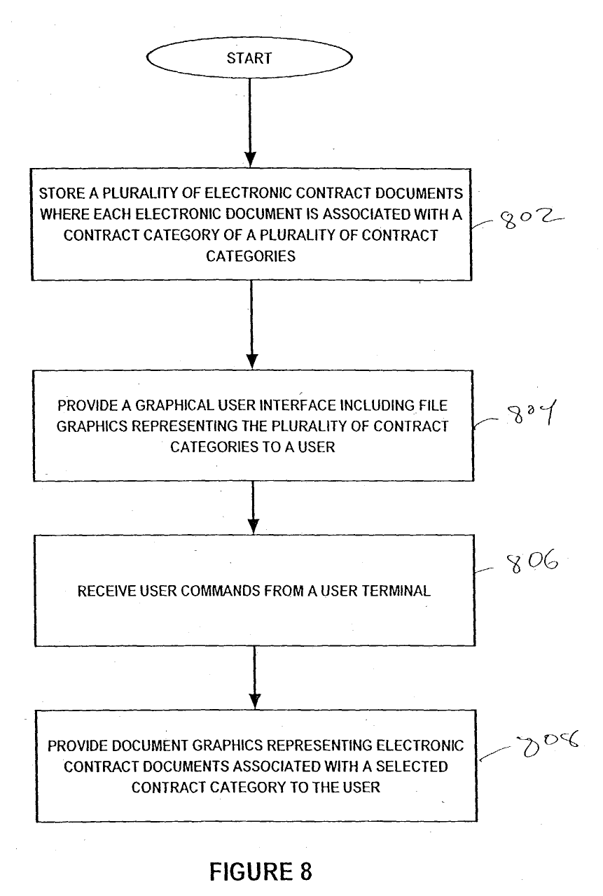

FIG. 8 is a flow chart of a method of managing electronic contract documents in accordance with the exemplary embodiment of the invention. Although the method can be performed in a variety of software and hardware configurations, the method is performed in the contract management server 102 in the exemplary embodiment.

At step 802, a plurality of electronic contract documents are stored where each electronic contract document is associated with a contract category of a plurality of contract categories. In the exemplary embodiment, documents are stored such that each is associated with either a contract form category, an active contract category, or a an executed contracts category. Although the data pertaining to the contract documents may be physically stored in any number of ways, the electronic documents are associated with a particular contract category.

At step 804, graphical user interface is provided to the user where the (GUI) includes graphics representing the plurality of contract categories. As explained above, the contract management home page 200 includes icons representing the electronic the different contract categories. In order to access document within a particular category, the user sends a command identifying the appropriate category or icon.

At step 806, the user commands are received. In the exemplary embodiment, the used commands are transmitted using Internet techniques such as TCP/IP. The user may use an input device 112 such as mouse to click on an icon. The mouse commands are converted to the appropriate format and transmitted though the communication network 106 to the server 102.

At step 808, the document graphics representing the electronic contract documents associated with a selected contract category are provided to the user. The server transmits the appropriate HTML, ASP or XML instructions to the web browser running on the user terminal that results in a graphics representing each of the electronic documents associated with the category selected by the user.

When a contract is fully and finally negotiated and then signed (executed) it establishes rights and obligations for the parties and a time frame during which certain performance milestones will occur. A contract which has been executed and which has come into force is called an “executory contract” or an “executed contract”. The invention provides for management of the documents in the file of an executed contract as set forth above. The invention also provides for active chronological monitoring of events such as performance milestones, renewal, and termination of an executed contract, and for notification of selected persons and organizations as time progresses toward the events. Moreover, the invention merges the management of contract file documents with the chronological management of contract performance events to provide a compound automated executed contract management function.

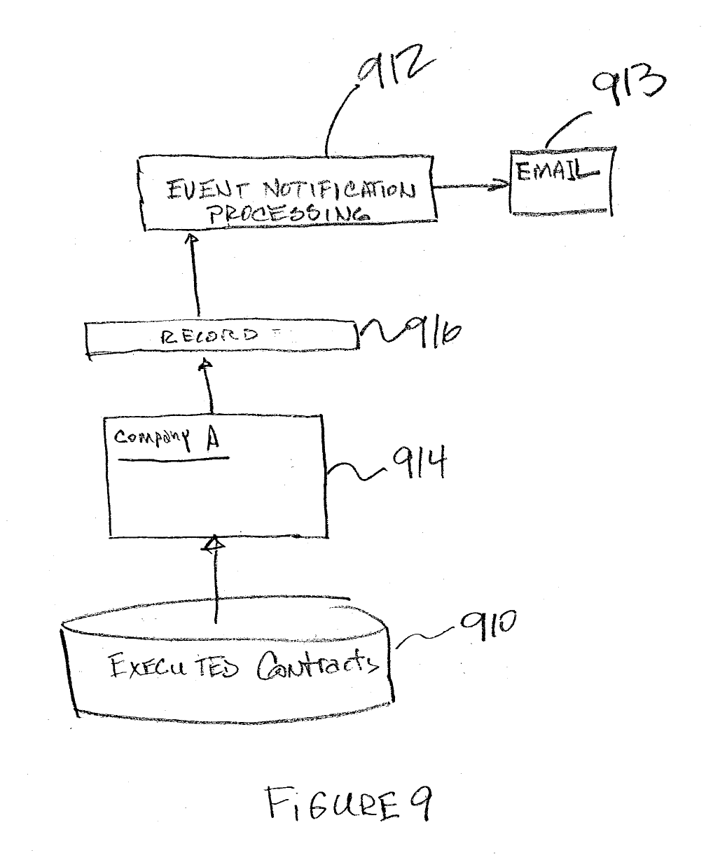

Refer now to FIGS. 9, 10, and 11 for an understanding of the chronological management of contract performance events according to this invention. This aspect of the executed contract management function depends upon the aggregation and organization of information in an executed contract about events in order to monitor progress toward those events and notify those persons and organizations having some responsibility or interest in the events as they approach and arrive. The information necessary for this monitoring and notification may be obtained from fields of GUI pages used in the creation of an active contract or obtained from fields of the electronic form of an executed contract which is created in the manner described above and then stored in an executed contracts database.

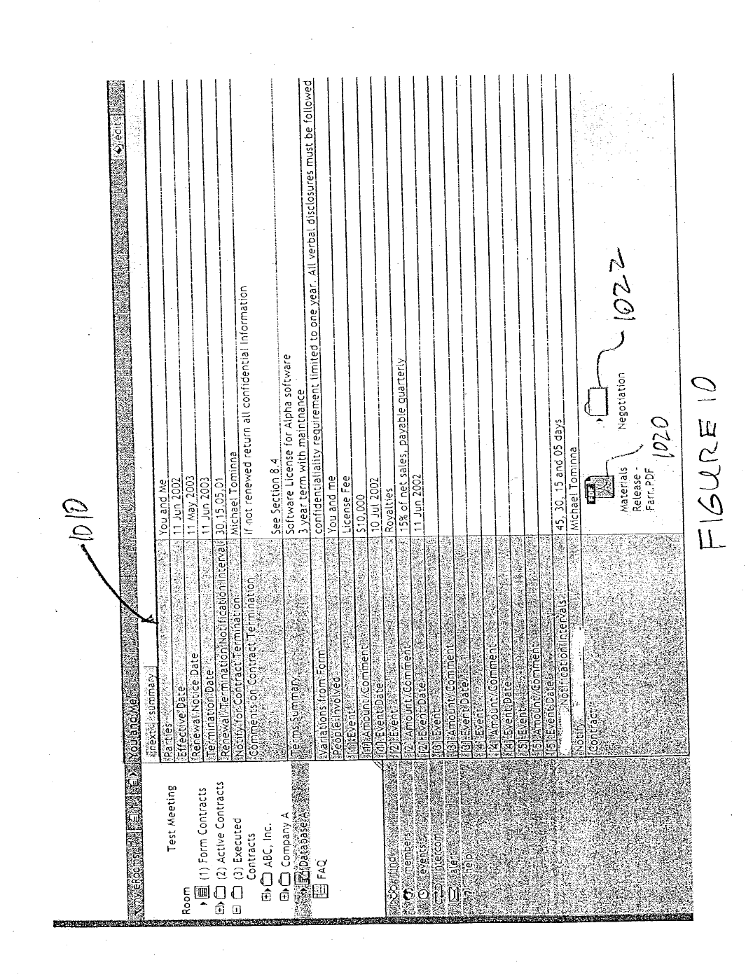

In FIG. 9, there is an executed contracts database 910 wherein records are stored that are linked to (or may contain), electronic forms of executed contracts and related documents. The database records contain fields for storing information used by a computer-executable event monitoring and notification process 912 having access to the facilities of a computer-executable messaging process 913 (for example, an email process) to which the event notification process 912 is linked. In this regard, a “computer-executable” process may be embodied in a software program containing commands in a particular sequence capable of being executed by a general or a special purpose digital computer which causes the computer to perform the functions and to achieve the purposes and objectives of this invention. Continuing with the explanation of the example illustrated in FIG. 9, an executed contract 914 with Company A has a corresponding record 916 stored in the executed contracts database 910. Some of the fields that the record 916 contains are represented in the page of FIG. 10. The page of FIG. 10 is one of a nested series of pages and it may be accessed by selection of the “EXECUTED CONTRACTS” field in any of the pages shown in FIGS. 2 and 4-7.

The shaded column 1010 of the page illustrated in FIG. 10 illustrates fields in the database record 916 that contain control information used by the event notification process 912 to count down to and notify of events as associated event dates approach during the lifetime of an executed contract. These events are categorized into at least two broad classes: termination events and milestone events. Termination events are events that signify the approach and arrival of the end of a contract. Two such termination events are a renewal date and a termination date. A renewal date is a date on which one or more designated persons or organizations are notified of the imminent expiration of a contract. A termination date is a date on which a contract expires and one or more designated persons or organizations are notified of the expiration. A milestone event is any other action, performance, or occurrence that is associated with a date in the executed contract. For example, a milestone event may be a date for shipment of goods, or for a periodic report. As with termination events, one or more designated persons or organizations may be notified of the imminence and arrival of milestone events.

Consider now the specific control fields of the database records and the contents of those fields that are illustrated in FIG. 10 in the exemplary context of a contract associated with Company A. The parties to the contract are “you and me”, and the effective date of the contract, that is, the day on which the contract comes into force, is 11 Jun. 2002. The renewal date is 11 May 2003, and the contract expires on 11 Jun. 2002. A Renewal/Termination Notification Interval field contains the entry 30,15,05,01 signifying that the person or organization identified in the field entitled “Notify For Contract Termination” (“Michael Tominna”) will be notified of the date of the Renewal Notice Date (11 May 2003) four times before that date, with notification being contained in email messages dispatched 30 days, 15 days, 5 days, and 1 day prior to 11 May 2003. According to the invention, Michael Tominna is also notified on the of renewal on the Renewal date of 11 May 2003. Similarly, as the expiration date approaches, Michael Tominna will be notified of the Termination date 30 days, 15 days, 5 days, and 1 day prior to 11 Jun. 2003. He will receive a final notification of termination on the Termination date of 11 Jun. 2003. For example, a Termination notification message addressed to Michael Tominna on 6 Jun. 2003 (five days before the Termination date of 11 Jun. 2003) might read “Company A contract to expire on 11 Jun. 2003”.

Control fields in the database record 916 that are associated with milestone events can be understood with reference to the page illustrated in FIG. 10; these fields are under the Terms Summary field. Each event has a plurality of control fields, each containing information identifying some aspect of the event. In the illustrative example, there are at least three fields for each milestone event: an Event Field which identifies the event, an Amount/Comment field which contains a summary of a term associated with the event, and an Event Date field containing the date on which the event is to occur or be completed. The three control fields for a first event, signified by [1], identify the event as a license fee, give its amount as $10,000, and identify its completion or occurrence date as 10 Jul. 2002. Five milestone events are identified in the control fields of the page shown in FIG. 10. The final two control fields establish notification intervals for all of the milestone events and one or more persons to be notified on each. The control exerted by these last two fields is distributed across all five of the milestone events established for the Company A contract. This is not meant to so limit the invention, as fields for separate notification interval sequences and addressees can be provided for each milestone event.

According to the example, Michael Tominna will be notified by email of each milestone event five times: 45 days, 30 days, 15 days and 5 days before the event, and on the day of the event. For event 1, a notification message addressed to Michael Tominna on 5 Jul. 2002 (five days before the event date of 10 Jul. 2002) might read “Company A contract License fee of $10,000 due on 10 Jul. 2002”.

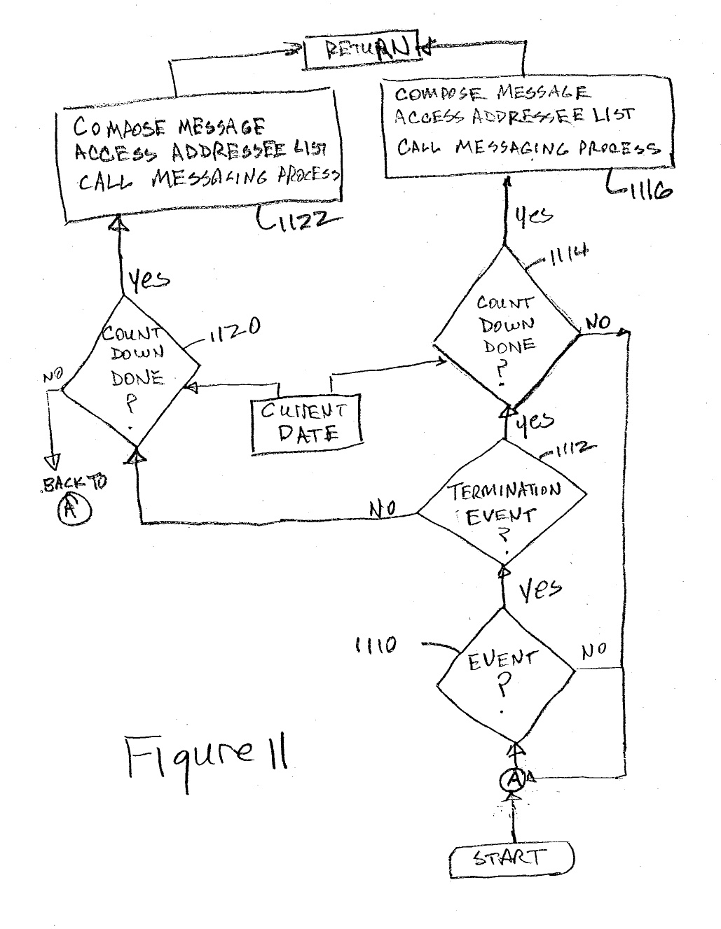

FIG. 11 illustrates a computer-executable method performed by the event notification process 912, using the resources of the messaging process 913. The event process 912 continuously accesses the database records stored in the executed contracts database 910 and uses the control field contents in each record to determine whether notification is required for any event. If notification is required, the event notification process 912 assembles a notification message, accesses an address list to obtain email addresses of all persons and organizations to be notified, and passes the message and an addressee list to the messaging process 913 for assembly and dispatch of a message (such as an email) containing the message to all members on the addressee list. Thus, in step 1110, the process 912 obtains a record and in step 1112 determines which termination and milestone events are identified in the database record. For termination events, the process 912 performs the processing step 1114 to determine if the time has come to send notification of the event. Using the current date, the effective date of the contract, the event date, and the Renewal/Termination Interval field, the process 912 determines whether the count down to a notification has been completed. If not, the control fields for the next event are accessed in step 1110 and processing continues. If a count down has been completed, the process 912 proceeds from step 1114 into step 1116 composes a message and an addressee list, passes these items to the messaging process 913, and returns to step 1110. Similar processing for milestone events is executed in the loop 1110, 1112, 1120, 1122, 1110. When all events have been processed in this way, the next database record is accessed, and so on.

Finally, the architecture, functionality, and procedure illustrated in FIGS. 9-11 for chronological management of an executed contract is linked to the executed contract itself by virtue of the icon 1020 which provides access to an image of the executed contract in a PDF file. Moreover, the icon 1022 completes the compound management function by providing a link to the other documents of the file of the executed contract.

Clearly, other embodiments and modifications of this invention will occur readily to those of ordinary skill in the art in view of these teachings. Therefore, this invention is to be limited only by following claims, which include all such embodiments and modifications when viewed in conjunction with the above specification and accompanying drawings.

I Claim:

1. A system for the collaborative creation, negotiation, and management of contracts, comprising:
a database implemented in a memory and comprising a plurality of electronic contract documents, each electronic contract document associated with a contract category of a plurality of contract categories;
a plurality of user terminals;
a communication means for coupling the plurality of user terminals to the database; and
means for providing at the plurality of terminals a graphical user interface (GUI) with graphics representing an association between the plurality of electronic contract documents and the plurality of contract categories.

2. The system of claim 1, wherein the GUI includes file graphics representing the plurality of contract categories.

3. The system of claim 2, wherein the GUI further comprises document graphics representing the electronic contract documents.

4. The system of claim 3, wherein the plurality of contract categories includes a contract forms category, an active contracts category and an executed contracts category.

5. The system of 4, wherein the electronic contract documents associated with the executed contracts category comprise:
an electronic word processing document that can be edited by a word processing application; and
an image document representing an executed contract corresponding to the electronic word processing document.

6. The system of claim 4, further comprising a contract server, the communication means further for connecting the contract server to the database and the plurality of user terminals, the contract server comprising a processor for executing commands received from the plurality of user terminals.

7. The system of claim 6, wherein at least one of the plurality of terminals is an active user terminal, the communications means includes a wide area network, and the contract server provides commands for producing the GUI through a Web browser application running on the active user terminal in response to messages sent from the active user terminal.

8. The system of claim 7, wherein the file graphics comprise:
a contract forms icon representing the contract form category;
an active contracts icon representing the active contracts category;
and, an executed contracts icon representing the executed contracts category.

9. A system for the collaborative creation, negotiation, and management of contracts, comprising:
a memory;
database implemented in the memory for storing a plurality of electronic contract documents associated with an organization, each electronic contract document associated with a contract category of a plurality of contract categories, the plurality of contract categories comprising at least a contract forms category, an active contracts category and an executed contracts category, the plurality of electronic contract documents comprising a contract form document associated with the contracts forms category, an active contract document associated with the active contracts category and an executed contract associated with the executed contract category;
a plurality of user terminals;
each of the plurality of user terminals for providing a graphical user interface (GUI) including graphics representing an association between the electronic contract documents and the plurality of contract categories;
a contract server connected to the database, the contract server for communicating with the plurality of user terminals and providing access to a selected electronic contract document in response to user commands entered through an input device connected to an active user terminal; and
a communication network for connecting the contract server with the plurality of user terminals.

10. The system of claim 9, the contract server for generating graphic instructions for producing the GUI through a Web browser application running on the active user terminal in response to the commands received from the active user terminal.

11. A contract management server comprising:
a memory comprising a plurality of electronic contract documents, each electronic document associated with a contract category of a plurality of contract categories; and
a processor for generating graphics instructions to provide a graphic user interface when received at a user terminal, the graphical user interface (GUI) comprising graphics representing an association between the plurality of electronic contract documents and the plurality of contract categories.

12. The server of claim 11, further comprising a communication interface for transmitting the graphics instructions through a communication network to the user terminal.

13. The server of claim 12, wherein the GUI includes file graphics representing the plurality of contract categories.

14. The server of claim 13, wherein the GUI further comprises document graphics representing the electronic contract documents.

15. The server of claim 14, wherein the plurality of contract categories includes a contract forms category, an active contracts category and an executed contracts category.

16. The server of claim 15, wherein the electronic contract documents associated with the executed contracts category comprise:
an electronic word processing document that can be edited by a word processing application; and
an image document representing an executed contract corresponding to the electronic word processing document.

17. The server of claim 15, the processor for executing commands received from the user terminal through the communication interface.

18. The server of claim 17, the processor for providing graphics instructions for producing the GUI through a Web browser application running on an active user terminal in response to the commands.

19. The server of claim 18, wherein the file graphics comprise:
a contract forms icon representing the contract form category;
an active contracts icon representing the active contracts category; and
an executed contracts icon representing the executed contracts category.

20. The server of claim 19, wherein the commands are initiated by an input device connected to the user terminal, the contract server providing access to the electronic contract documents associated with a selected contract category of the plurality of contract categories in response to the user commands entered through the input device indicating the selected category.

21. The server of claim 20, wherein the user commands comprise an identification of a selected file of the file graphics.

22. The server of claim 21, wherein at least some of the plurality electronic documents include annotations.

23. A method for collaboratively creating, negotiating, and managing contracts associated with an organization, the method comprising:
storing a plurality of electronic contract documents, each electronic document associated with a contract category of a plurality contract categories; and
providing a graphical user interface (GUI) including file graphics representing the plurality contract categories to a user.

24. The method of claim 23, wherein the GUI includes file graphics representing the plurality of contract categories.

25. The method of claim 24, wherein the GUI further comprises document graphics representing the electronic contract documents.

26. The method of claim 25, further comprising, in response to user commands entered through an input device at a user terminal, providing the document graphics representing electronic contracts documents associated with a selected contract category of the plurality of contract categories.

27. The method of claim 26, wherein the contract categories comprise:
a form contract category classifying contract form documents used for preparing a contract;
an executed contract category classifying executed contract documents; and
an active contract category classifying active contracts documents in a state of completion between the form status and the executed status.

28. The method of claim 27, wherein the executed contract category comprises:
an in-effect status classifying executed contract documents legally binding on at least one party; and
an expired status classifying executed contract documents lacking legal obligations on any party.

29. The method of claim 27, wherein the providing document graphics representing electronic contracts documents comprises transmitting, through a communication network, graphics instructions invoking generation of the document graphics at a user terminal.

30. The method of claim 27, wherein the electronic contract documents associated with the executed contracts category comprise:
an electronic word processing document that can be edited by a word processing application; and
an image document representing an executed contract corresponding to the electronic word processing document.

31. The method of claim 27, further comprising executing commands received from the user terminal through the communication interface.

32. The method of claim 31, wherein the file graphics comprise:
a contract forms icon representing the contract form category;
an active contracts icon representing the active contracts category; and
an executed contracts icon representing the executed contracts category.

33. The method of claim 31, wherein the commands are initiated by an input device connected to the user terminal, the contract server providing access to the electronic contract documents associated with a selected contract category of the plurality of contract categories in response to the user commands entered through the input device indicating the selected category.

34. The method of claim 33, wherein the user commands comprise an identification of a selected file of the file graphics.

35. A method in accordance with claim 34, wherein at least some of the plurality electronic documents include annotations.

36. A graphical user interface for use in a system for collaborative creation, negotiation, and management of contracts, comprising:
file graphics representing a plurality of contract categories of contracts of an organization and comprising a contract forms category, an active contracts category and an executed contracts category; and
document graphics representing a plurality of electronic contract documents, the graphic user interface indicating an association between each of the electronic contract documents and a contract category of the plurality of contract categories.

37. The graphical user interface of claim 36, wherein:
the contract forms category classifies contract form documents used for preparing a contract;
the executed contract category classifies executed contract documents; and
the active contract category classifies active contracts documents in a state of completion between the contract forms category and the executed contract category.

38. The graphical user interface of claim 37, wherein document graphics representing the electronic contract documents associated with the executed contracts category comprise:
a word processing graphic representing an electronic word processing document that can be edited by a word processing application; and
an image document graphic representing an image document representing an executed contract corresponding to the electronic word processing document.

39. The graphical user interface of claim 38, wherein the file graphics comprise:
a contract forms icon representing the contract form category;
an active contracts icon representing the active contracts category; and
an executed contracts icon representing the executed contracts category.

40. A system for managing executed contracts, including:
a database for storing records;
a plurality of records representing executed contracts stored in the database;
at least one record of the plurality of records containing control fields representing events of an executed contract; and,
a computer-executable notification process for accessing the at least one record and causing notification of events in response to information contained in the control fields.

41. The system of claim 40, wherein a plurality of the control fields in the at least one record represent termination events.

42. The system of claim 40, wherein a plurality of the control fields in the at least one record represent milestone events.

43. The system of claim 40, wherein a first plurality of the control fields in the at least one record represent termination events and a second plurality of the control fields in the at least one record represent milestone events.

44. The system of claim 43, further including a computer-executable messaging process linked to the notification process for dispatching messages containing notification messages to one or more identified recipients.
